(19) United States
(12) Patent Application Publication
(10) Pub. No.: US 2003/0050869 A1
(43) Pub. Date: Mar. 13, 2003

(54) Product content collaboration tool, system, software, method

(75) Inventor: Geert Frank Bruynsteen, Sunnyvale, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONIC N.V.

(21) Appl. No.: 09/952,063

(22) Filed: Sep. 13, 2001

(51) Int. Cl. G06F 17/60

(52) U.S. Cl. 705/28

(57) ABSTRACT

A product content collaboration tool allows collaborative communication of commercial information, such as part pricing and availability. Advantageously, the tool enhances communication between an OEM and CEM. The tool is integrated into a technical product development information environment.

### I. BACKGROUND OF THE INVENTION

A. Field of the Invention

The invention relates to the field of product content collaboration.

B. Related Art

The following abbreviations will be used herein:

OEM=Original Equipment Manufacturer. In this context, this will mean a concern that defines and markets products.

CEM=Contract Electronics Manufacturer. Herein, this will mean a concern that manufactures designs from an OEM under contract.

AVL=Approved Vendor List

PDM=Product Data Management

In the past OEM's tended to manufacture their products close to their design centers, often manufacturing and design were located at the same site. Later manufacturing and design got separated but stayed with the same company. In recent years we have seen a growing trend to outsource manufacturing/logistics/service to specialized companies. The goal of this movement is to reduce cost, supply chain risk and improve asset utilization.

The separation of design and manufacturing, not only geographically but also amongst different companies, has created problems of its own, reducing the benefits. Problems often result from two companies with different culture and processes, different language, lack of secure and reliable communication, etc. For instance, the OEM and CEM may both be negotiating with the same vendor, who is a sub-contractor of components, but the vendor may cite different prices to the OEM and the CEM. Or the vendor may cite different parts quantity availability to both, not realizing that the parts are destined for the same product. Or both the OEM and CEM may each have several employees, each negotiating with distinct vendors; and it may be necessary to coordinate communications as to which negotiator got the best price and for what quantity of parts.

FIG. 1 is a schematic of the information exchange between an OEM on the left, and a CEM 101 on the right. The design department 102 of the OEM communicates technical information 104 to the contract electronics manufacturer 101 and gets technical feedback 104′. The purchasing department 103 of the OEM communicates commercial information 105′ to the CEM 101 and receives back feedback 105′.

To be successful in outsourcing a good communication is critical. Software vendors have tried to address this need with various tools, called ‘Product Content Collaboration’ tools. These include the PDM's that manage Bills of Material (BOM). Such product content collaboration software communicates technical info 104 and allows the CEM to give feedback 104′. An example of such a product is AGILE, sold by Agile Software, www.agilesoft.com; and Product Lifecycle sold by SAP at www.sap.com.

Enterprise Resource Planning (“ERP”) systems exist, which manage goods flow in a factory, logging what has passed through and what is in future Purchase Orders (PO) and keeping track of prices actually paid. An example of an ERP system is MFG/PRO available from QAD at www.qad.com, though other companies such as SAP also have them. However, these systems are not collaborative and do not deal with the negotiating process.

### II. SUMMARY OF THE INVENTION

It is desirable to improve collaboration on commercial information 105, 105′ between concerns involved in contracting for manufacturing.

Advantageously, commercial information relating to product content is made available in a product content collaboration tool. The tool identifies discrepancies and/or gaps in the commercial information. These discrepancies and/or gaps are communicated to at least one user, so as to allow the user to resolve them.

The discrepancies and/or gaps may relate to any type of commercial information, such as pricing and/or availability of parts.

Advantageously, also, the tool may be used to enhance bilateral negotiation between an OEM and a CEM.

Technical information is preferably integrated into the tool along with the commercial information so that commercial information may be coordinated with technical information.

The tool is preferably incorporated within at least one data processing device. It may be embodied in software.

Use of the techniques of the tool can result in cost savings and improved quality in the resulting product as well.

The invention has been briefly described above within a context of collaborative manufacturing. It is clear to the skilled person that a similar method is feasible and advantageous within a context of a collaborative service wherein, for example, a project owner outsources the providing of various services constituting the project to subcontractors. For example, a travel agency provides an all-in vacation with services provided by restaurants, hotels, transportation companies, and by individual guides and professional assistants. As another example, a company (e.g., a TV broadcasting station, an Internet content broker, a video-on-demand service, another content service provider, etc.) sets up an infrastructure with parties who are to deliver a service or component, in order to enable electronic content to be delivered to a community of subscribers. These subcontracting parties comprise, e.g., network operators, content owners, electronic program guide (EPG) services, set top box manufacturers, etc., in order to enable electronic content to be delivered to a community of subscribers. In these examples, each of these service components is pre-specified according to service content, similar to the product content described above. Commercial information relating to service content is made available in a service content collaboration tool. The tool identifies discrepancies and/or gaps in the commercial information. These discrepancies and/or gaps are communicated to at least one user (sub-contractor, project owner), so as to allow the user to resolve them. Making the commercial information visible within a collaborative context clarifies the responsibilities of the parties involved and facilitates managing the project. Accordingly, the word “product” used in this text to indicate a collaborative manufacturing environment, may also refer to a service or component thereof in a collaborative service providing environment.

### III. BRIEF DESCRIPTION OF THE DRAWING

The invention will now be described by way of non-limiting example with reference to the following drawings.

FIG. 1 is a schematic of the collaboration process between the OEM and the CEM.

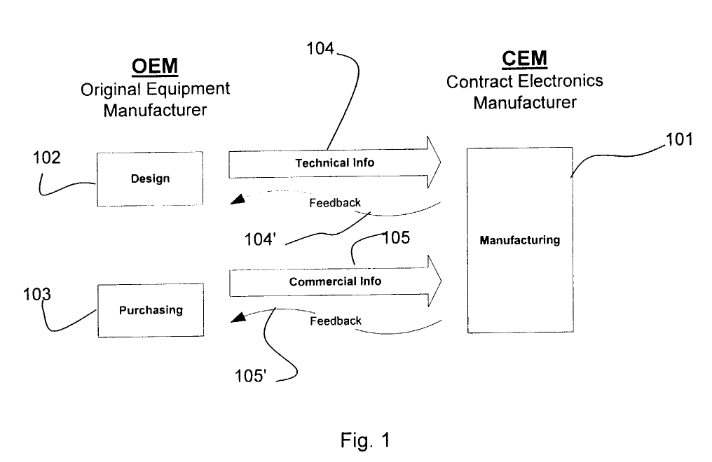

FIG. 2a shows hardware on which a system in accordance with the invention may be run.

FIG. 2b shows sharing of commercial information in accordance with the invention.

FIG. 3 shows an alternative embodiment of FIG. 2b.

FIG. 4 shows schematically how the invention fits in with other software systems used in the manufacturing planning process.

FIG. 5 shows a record format.

FIG. 6 shows an information flow diagram between users of the invention.

### IV. DETAILED DESCRIPTION OF THE PREFERRED EMBODIMENTS

Generally, the present disclosure is based on a software implementation. However, those of ordinary skill in the art might equally well provide a hardware or hybrid embodiment.

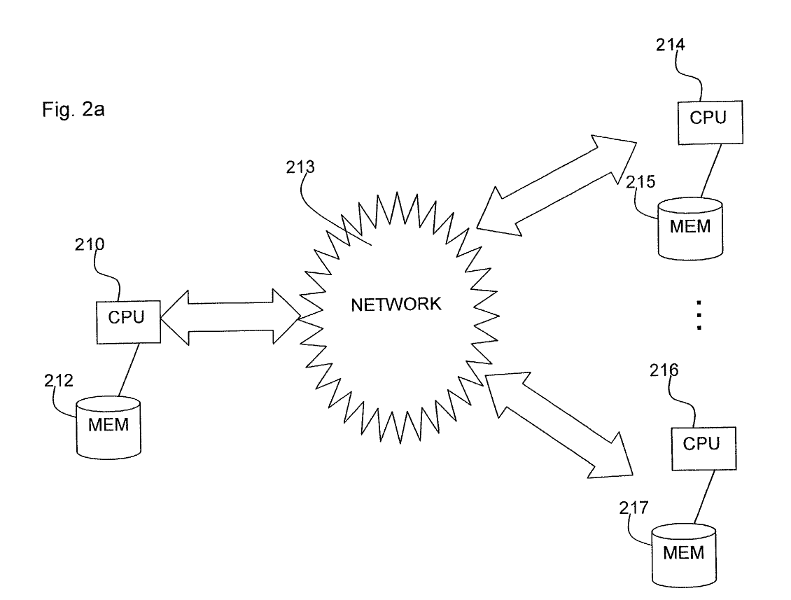

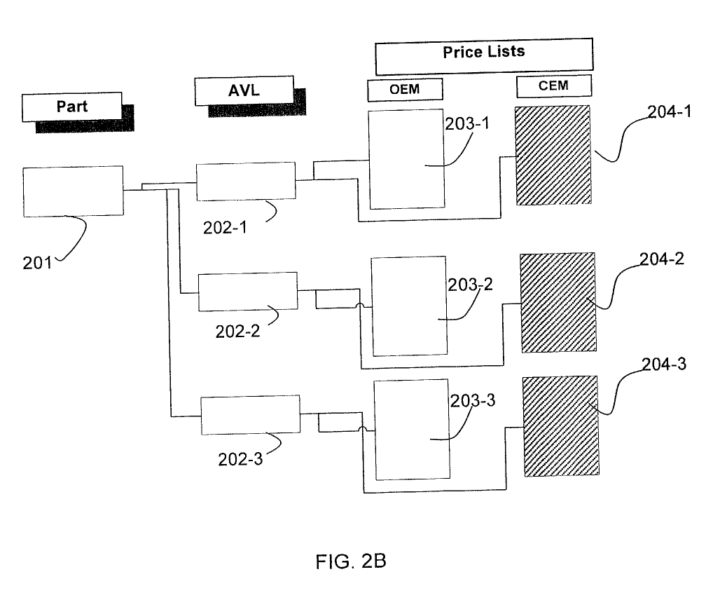

FIG. 2a shows hardware for implementing a system in accordance with the invention. Generally, a server 210 will maintain a database of information on its associated memory 212. It would normally be expected that the OEM, which is ultimately going to put its name on the manufactured product, will maintain the server 210. Various people sharing commercial information will then communicate with the server 210 via network 213 using their own local processing capabilities 214, 216 and their own local data 215, 217. The network may be of any sort, but will typically include a LAN—in the buildings where the processors 210, 214, and 215 are located—and a more extensive network, such as the Internet, for communicating between different concerns. While the database is depicted as localized to a single server 210, it might also be implemented in a distributed fashion with parts of the information being maintained in real time at various different locations. Each processor, 210, 214, 216, will typically have peripherals such as input and output devices for the user; but these are not shown, because they are not relevant to the invention.

FIG. 2b shows the structure of information used in the invention. As explained before, this information may be located on a server or distributed onto the computers of several collaborators. Generally, a list of parts 201 will be pulled directly from the BOM generated by the PDM. The part identifiers will be indexed against vendors 202 on the AVL. In this example, for the part in question, there are 3 approved vendors 202-1, 202-2, and 202-3. OEM and CEM personnel can enter their information about price and availability for each vendor. Then price/availability lists sorted by part number can then be assembled at 203 for the OEM and at 204 for the CEM. Thus the OEM's parts/availability list for vendor 1 is at 203-1, for vendor 2 is at 203-2, and for vendor 3 is at 203-3. Similarly, the CEM's parts/availability list for vendor 1 is at 204-1, for vendor 2 is at 204-2, and for vendor 3 is at 204-3.

In this embodiment, the parts lists are displayed for each vendor, in other words the parts are sorted first by vendor and then by part number. Alternatively, the parts might be sorted in some other fashion, for instance by part number first, and then by vendor, if there is more than one vendor for a part.

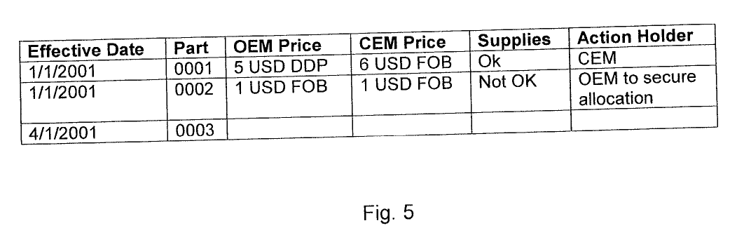

The system must create a combined list from the information held by the OEM and the information held by the CEM. An embodiment of a combined list is shown in the table at FIG. 5. In this table, the first column shows the date at which the data was last updated, i.e., the effective date. The second column shows the part number from the BOM. The third column shows the best price as known to the OEM. The fourth column shows the best price as known to the CEM. The fifth column indicates whether supplies for the parts are sufficient. The sixth column indicates who has taken responsibility for securing this part. In the first row of the table there is a price discrepancy. The OEM thinks that the price is 5 US dollars Delivery Duty Paid (“DDP”), while the CEM thinks that the price is 6 US dollars Free on Board (FOB). This type of discrepancy will commonly arise when the amount budgeted for a part by the OEM is less than the actual price of the part encountered by the CEM in obtaining quotes. The system must therefore signal to the parties that some action needs to be taken to clarify the price. The signal may take the form of some change in the table display, for instance flashing the two prices. Alternatively, the signal may take the form of a pop up window at the workstation of the responsible user; however the signal may take other forms, such as sending the responsible party an e-mail or a telephone call with a recorded message, depending on the desired design. In this case, the action holder, i.e. the responsible party, is the CEM. Therefore, upon receiving the signal of the price discrepancy, the CEM must contact the vendor and the OEM and resolve the price discrepancy. The table merely lists “CEM” as the action holder; however, if desired, the skilled artisan may allow for the possibility that an individual or a department may be identified as action holder, along with a phone number and/or e-mail address at which the individual or department is to be contacted.

In the second row of the table, the prices cited to the OEM and CEM are the same. However, there is a problem with adequacy of supply. Accordingly, again there is a problem that requires resolution. In this case, the OEM is listed as the action holder. Therefore the OEM must call the supplier and the CEM and attempt to resolve the problem of sufficiency of supply. If the vendor who is selling at this price cannot give adequate supply, an additional row may need to be added to the table to account for a second supplier who may be selling at a higher price, but who may have more availability.

Advantageously, the table may be designed with an additional column so that both the OEM and CEM view of the adequacy of supplies may be listed, and any differences in viewpoint identified.

The third row of the table shows a part whose price, availability, and action holder are completely unidentified. In this case, a signal must be sent to some default action holder, usually someone at the OEM facility, who can at least designate someone to get this part into a more advanced stage of negotiation.

The table may have other information as well, for instance the perceived reliability of a supplier or the perceived quality of particular ones of that supplier's parts might be noted in additional columns, not shown. Such supplemental types of information might be weighed—together with price and availability—by the CEM and the OEM in deciding which competing supplier to go with. As a result of considering all of these factors, the CEM and OEM will be able to optimize price, availability and quality factors in the finished product.

Various users may see different versions of the data of table of FIG. 5, for instance via different graphical user interfaces (GUI's), which may be customized, e.g., by using XML tags. Moreover, the data may be stored in different formats in the different systems communicating in accordance with the invention. In addition, certain users may have more or less information than is shown in FIG. 5.

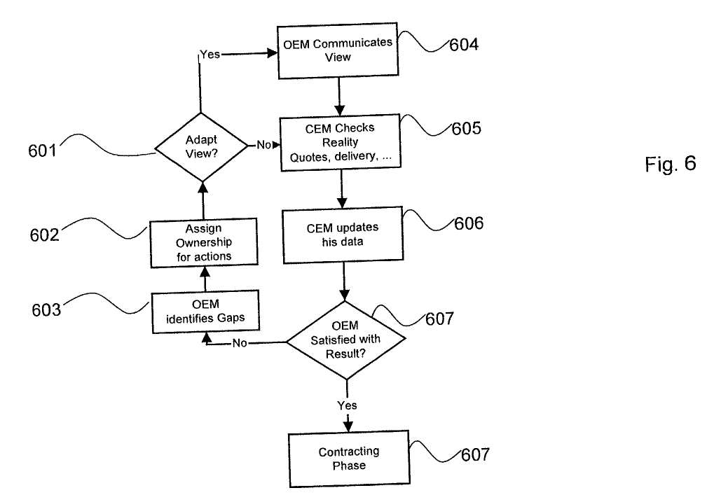

FIG. 6 shows an information flow diagram of how the system will be used in an actual contract negotiation. In general, flow through the diagram of FIG. 6 will be controlled by human action. However, the system can prompt these actions by sending reminder messages to those responsible for the actions.

At 604, the OEM communicates its view of price/availability. Then at 605, the CEM receives the communication and therefore must check reality, i.e. quotes and delivery expectations and experience. At 606, the CEM updates his data.

At 607 it is determined whether the OEM is satisfied with the result. If so, the CEM can go to contract on this particular part at 607. Alternatively, if the system is used in developing an overall contract price between the CEM and the OEM, the price for this individual part could be stored until all the prices are stabilized. If the OEM is not satisfied, it needs to identify gaps in the data at 603. Such gaps would be like those identified with respect to the table of FIG. 5.

After the gaps are identified, the OEM should attempt at 602 to assign ownership of any actions that need to be taken. Then, at 601, the OEM needs to decide whether to change its view of the facts. If it does want to change its view, then control returns to box 604. If not, control returns to box 605.

The system assigns actions and keeps track of them by assigning a “status”. For example, when a user is working on a specific subject, he flags it to change the status. The users key in the data for which they have ownership.

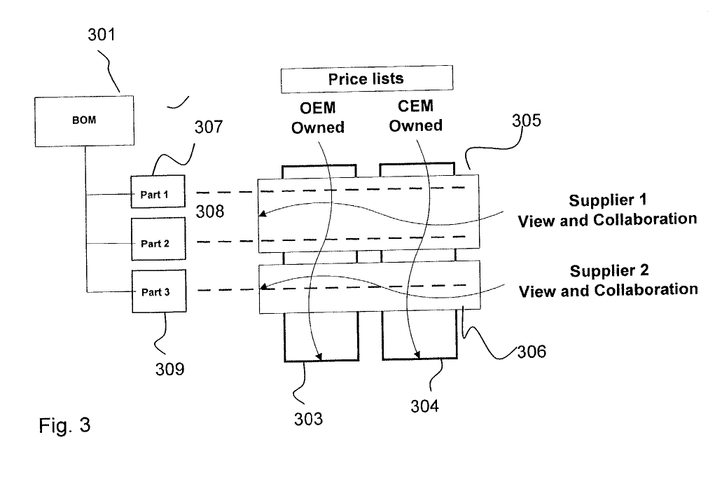

FIG. 3 shows an alternative embodiment of FIG. 2b. In this embodiment, as before, part numbers 1, 2, and 3—shown at 307, 308, and 309, respectively—are extracted from the BOM 301. Parts 1 and 2 are recognized to be from supplier 1, while part 3 is recognized to be from supplier 2. Supplier I is then given access to those sections 305 of the OEM and CEM owned parts lists—303 and 304, respectively—that relate to parts 1 and 2. Supplier 2 is given access to sections 306 relating to part 3. The suppliers can then see the discrepancies/gaps and undertake to resolve those for the CEM and OEM, proactively. Upon reading the database, the supplier may discover, for instance, that the reason that supplies appeared short was that the CEM and OEM had inquired about the same part without the supplier realizing that the inquiries were duplicates. Alternatively, the CEM or OEM can call the relevant supplier and ask the supplier to read the lists and clarify the correct price or availability figures.

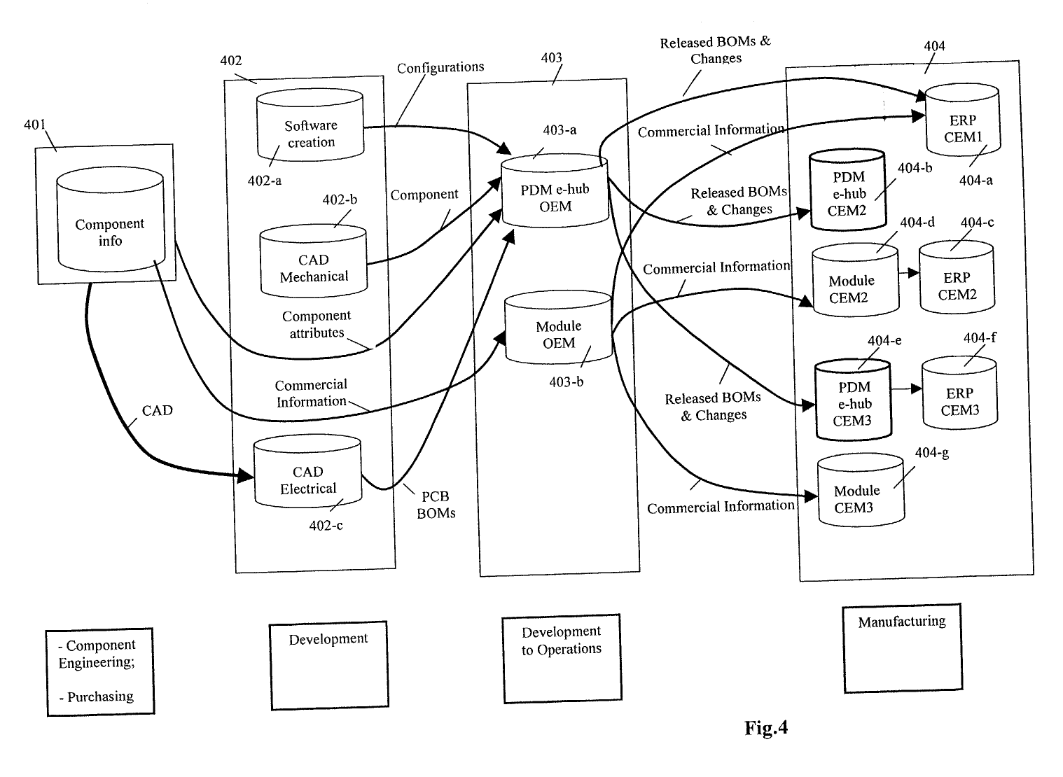

FIG. 4 shows the invention in a system context with other software available on the market. At 401 there is at least one database of component information maintained by component engineering and purchasing groups. This feeds CAD and commercial information into development systems 402 and BOM information into the PDM hub 403. The development systems will normally include at least one mechanical CAD system 402-b, such as Pro/Engineer from PTC, see www.ptc.com; at least one electrical CAD system 402-c, such as those available from Mentor Graphics, see www.mentorg.com; and other development software. The development software will feed component and configuration into the PDM hub.

The PDM hub 403 will commonly include software such as Agile Software's e-hub 403-a, and software in accordance with the invention 403-b. The existing hub feeds Released BOM's and changes directly to ERP systems at some CEM's, e.g. the ERP system of CEM1 at 404-a. In other cases the Released BOM's and changes will be fed into hubs maintained by the CEM's such as 404-b and 404-d maintained by CEM2 and CEM3, respectively. The CEM hubs 404-b and 404-d will then, in turn, feed local ERP systems, 404-c and 404-f, respectively. The CEM's that have hubs will also have modules in accordance with the invention 404-e and 404-g which share commercial information with the module at the OEM 403-b. The arrows shown in this figure may equally well be two way as one way.

Since the commercial information is integrated and coordinated with technical data from development-related software—such as the BOM from the PDM system—negotiation between the OEM and CEM may be enhanced during the development process, even before the specification of the product is complete.

From reading the present disclosure, other modifications will be apparent to persons skilled in the art. Such modifications may involve other features, which are already known in the design, manufacture and use of collaborative systems and which may be used instead of or in addition to features already described herein. Although claims have been formulated in this application to particular combinations of features, it should be understood that the scope of the disclosure of the present application also includes any novel feature or novel combination of features disclosed herein either explicitly or implicitly or any generalization thereof, whether or not it mitigates any or all of the same technical problems as does the present invention. The applicants hereby give notice that new claims may be formulated to such features during the prosecution of the present application or any further application derived therefrom.

The word “comprising”, “comprise”, or “comprises” as used herein should not be viewed as excluding additional elements. The singular article “a” or “an” as used herein should not be viewed as excluding a plurality of elements.

1. A product content collaboration tool comprising:
at least one memory adapted to store commercial information relating to product content;
at least one processor adapted to cause the following operations to be performed:
receiving and storing at least parts of the commercial information;
processing aspects of the commercial information to identify a discrepancy and/or gap in the commercial information; and
communicating the discrepancy and/or gap to at least one user, so as to allow the user to collaboratively resolve the discrepancy and/or gap.

2. The tool of claim 1, wherein the operations are iterated until any discrepancies and/or gaps are resolved.

3. The tool of claim 1, wherein
the commercial information represents at least one price for at least one part of the product; and
the discrepancy and/or gap represents a difference between price data in the possession of at least first and second users.

4. The tool of claim 1, wherein
the commercial information represents availability data for at least one part of the product; and
the discrepancy and/or gap represents an indication of lack of availability for the at least one part.

5. The tool of claim 1, wherein the communicating operation enhances bilateral negotiation between an OEM and a CEM.

6. The tool of claim 1, wherein the processor is further adapted to
receive and store technical information resulting from an engineering and/or software development process;
coordinate the technical information with the commercial information; and
enable a user to access at least parts of both the technical and the commercial information.

7. A system comprising
at least one tool in accordance with claim 1; and
at least one data processing device implementing the tool.

8. A data processing method including performing operations comprising:
receiving and storing, in a form readable by a data processing device, commercial information relating to product content;
processing aspects of the commercial information to identify a discrepancy and/or gap in the commercial information;
communicating the discrepancy and/or gap to at least one user; so as to allow the user to collaboratively resolve the discrepancy and/or gap.

9. The method of claim 8, wherein the operations further comprise iterating the operations until any discrepancies and/or gaps are resolved.

10. The method of claim 8, wherein
the commercial information comprises at least one price for at least one part of the product; and
the discrepancy and/or gap represent a difference between price data in the possession of at least first and second users.

11. The method of claim 8, wherein
the commercial information represents availability data for at least one part of the product; and
the discrepancy and/or gap represents a n indication of lack of availability for the at least one part.

12. The method of claim 8, wherein the communicating operation enhances bilateral negotiation between an OEM and a CEM.

13. The method of claim 8, wherein operations further comprise
Receiving and storing technical information resulting from an engineering and/or software development process;
Coordinating the technical information with the commercial information; and
Enabling a user to access at least parts of both the technical and the commercial information.

14. A product produced based on the commercial information whose discrepancies were resolved according to the method of claim 8.

15. A medium readable by a data processing device embodying code for performing operations comprising:
receiving and storing commercial information relating to product content;
processing aspects of the commercial information to identify a discrepancy and/or gap in the commercial information;
communicating the discrepancy and/or gap to at least one user; so as to allow the user to collaboratively resole the discrepancy and/or gap.

16. The medium of claim 15, wherein the operations are iterated until the discrepancies and/or gaps are resolved.

17. The medium of claim 15, wherein
the commercial information comprises at least one price for at least one part of the product; and
the discrepancies and/or gaps comprise a difference between price data in the possession of at least first and second users.

18. The medium of claim 15, wherein
the commercial information comprises availability data for at least one part of the product; and
the discrepancies and/or gaps comprise an indication of lack of availability for the at least one part.

19. The medium of claim 15, wherein the communicating operation enhances bilateral negotiation between an OEM and a CEM.

20. The medium of claim 15, wherein operations further comprise
Receiving and storing technical information resulting from an engineering and/or software development process;
Coordinating the technical information with the commercial information; and
Enabling a user to access at least parts of both the technical and the commercial information.
